(19) United States
(12) Patent Application Publication
(10) Pub. No.: US 2007/0165490 A1
(43) Pub. Date: Jul. 19, 2007

(54) Watch movement equipped with an animation

(76) Inventor: Sasnik Simonian, Antelias (LB)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 10/569,815

(22) PCT Filed: Aug. 27, 2004
(86) PCT No.: PCT/CH04/00542

§ 371 Date: Dec. 7, 2006

(30) Foreign Application Priority Data
Aug. 29, 2003 (EP) 03405624.2

(51) Int. Cl. G04C 17/00

(52) U.S. Cl. 368/223

(57) ABSTRACT

A mechanical-type watch movement is disclosed. In one implementation, the movement may include a frame. The frame may support a work train that is periodically driven in rotation by a driving element. The frame may also support an animation part. The animation part may be configured to be visible, and may be arranged to be animated by an oscillating movement that is capable of simulating, for example, a pendulum movement. The movement may also include, supported by the frame, an animation train that meshes with a mobile of the work train, and is kinematically connected to the animation part.

The present invention relates to watch movements of the type comprising a visible mobile element and ensuring an animation of the display.

More precisely, the present invention relates to a mechanical-type watch movement, comprising a frame and, supported by the frame:
a work train comprising a plurality of wheels and periodically driven in rotation by a driving element,
a mobile animated by a pulsed movement,
an animation part intended to be visible and arranged in such a way as to be animated by a periodic movement,
a control element for the animation part, and
an animation train in mesh with a mobile of the work train and driving the control element.

A watch movement of this type is described, for example, in patent CH 30.220, which proposes to animate a figurine by means of a wheel connected to the work train comprising ratchet teeth. The latter periodically drive a rod forming part of the automaton. Such a solution has the drawback that the movement of the automaton is jerky, owing to jumps over the ratchet teeth.

Furthermore, watches are known such as that described in document FR 630.190, in which a pendulum image is fixed on the pallet fork of the escapement. This image is thereby abruptly displaced with each alternation. Here, too, the movement is jerky and therefore more irritating than calming.

The object of the present invention is to realize an animation in which the jerks due to the pulsed movement of the escapement or of the motor are gradually dampened in order that the movement of the automaton is uniform and jerk-free. To this end, the watch movement according to the invention is characterized in that the animation train, the control element and the animation part are arranged in such a way that the periodic movement has a sinusoidal oscillation movement.

In order to obtain an optimal simulation quality, an elastic element is interposed between the mobile of the work train with which the animation train is in mesh and the animation part, thus forming a mechanical filter through the combination of the elastic element with the inertia of the mobiles of the animation train, of the control element and of the animation part.

From the point of view of the arrangement of the various components, it appears to be advantageous for the animation train to be connected to the work train by its seconds mobile. In this case, the animation train is arranged in such a way as to accelerate the rotation speed of the seconds mobile toward the mobile cooperating with the animation part.

Advantageously, the animation part oscillates at a frequency ranging between 0.2 and 2 Hz.

In one particular embodiment, the movement additionally comprises a lever. The last mobile of the animation train is equipped with a board. Moreover, the animation part and the board are equipped with eccentrically disposed connecting means arranged so as each to be connected to one of the ends of the lever, in order together to form a connecting rod connecting the animation train to the animation part.

In a first variant, the lever has, over at least a part of its length, an elastically deformable structure, arranged in such a way as to constitute said elastic element.

In a second variant, the elastic element elastically connects two coaxial mobiles of the animation train.

Advantageously, the elastic element forms, with the animation part and the mobile(s) of the train interposed between that which cooperates with the animation part and that which is connected to the elastic element, an oscillating system, the period of which ranges between that which is defined by the periodicity of the advancement of the work train and that of the alternating movement of said part.

In order to make the animation part as shockproof as possible, it is mounted pivotably on the frame and its center of gravity is located substantially on its pivot axis.

In order to allow the use of an already existing watch caliber, the frame of the movement according to the invention comprises:
a first plate and a first bridge, between which pivot the mobiles of the work train, and
a second plate on which pivot the mobiles of the animation train and the animation part, the plate, the animation train and the animation part together forming an independent module which can be fixed by the second plate onto the first plate.

It is clear that all or part of the animation train can likewise pivot within a bridge, which bridge is fixed on the second plate.

Other advantages and characteristics of the invention will emerge from the following description, made with regard to the appended drawing, in which:

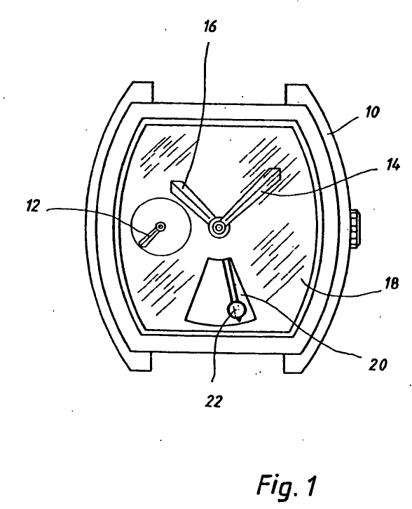

FIG. 1 represents a watch equipped with a watch movement according to the invention,

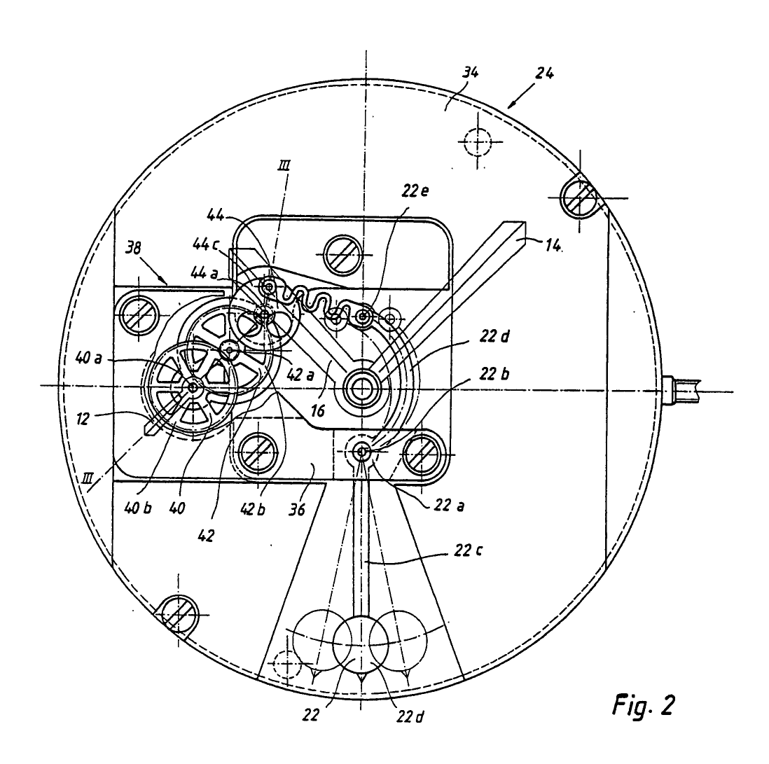

FIG. 2 is a plan view of a part of the watch movement according to the invention, which carries out the animation function, and

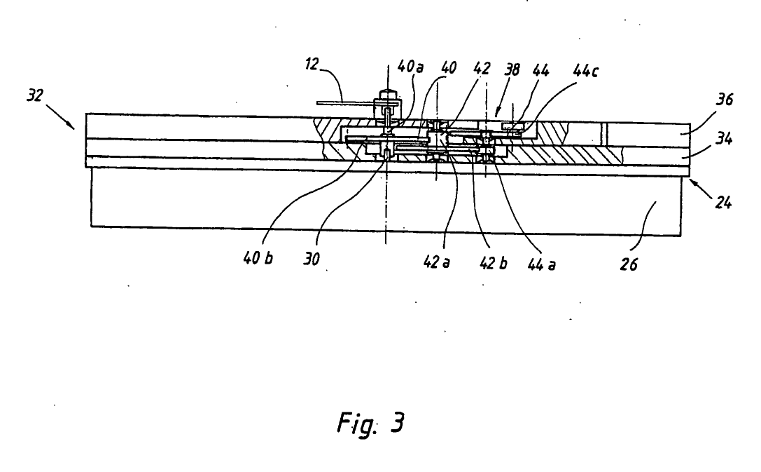

FIG. 3 is a sectional view along the lines III-III of the movement part illustrated in FIG. 2,

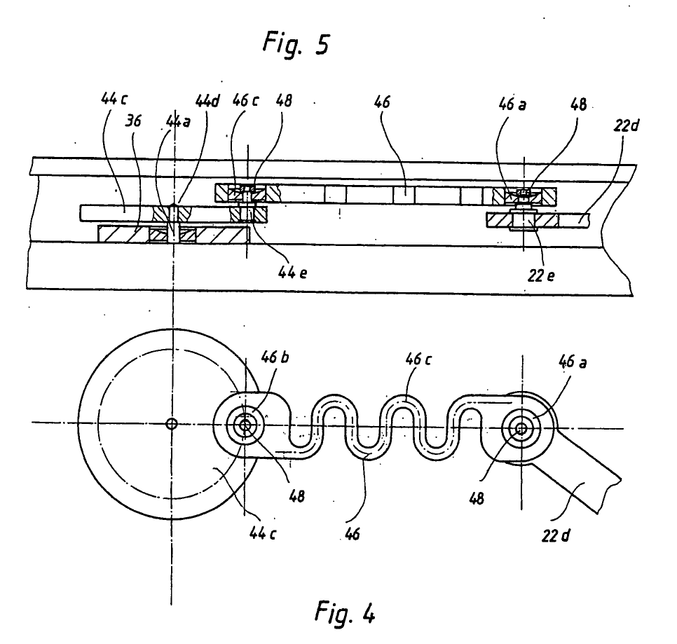

FIGS. 4 and 5 show, on a larger scale and respectively in plan view and in section, a part of the movement of FIGS. 2 and 3,

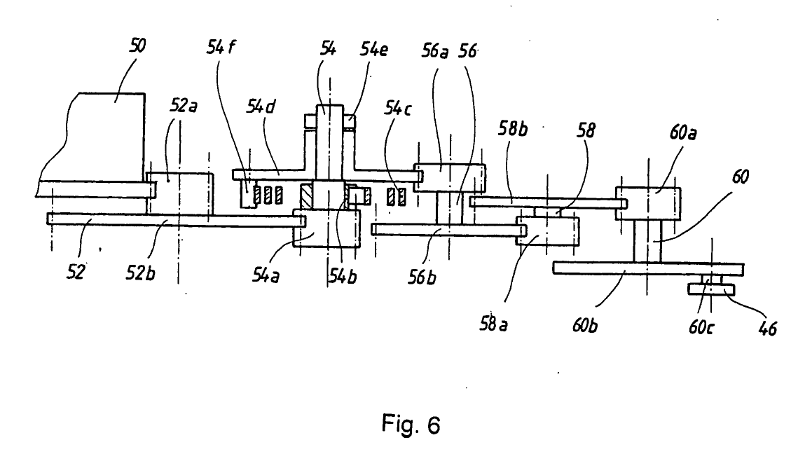

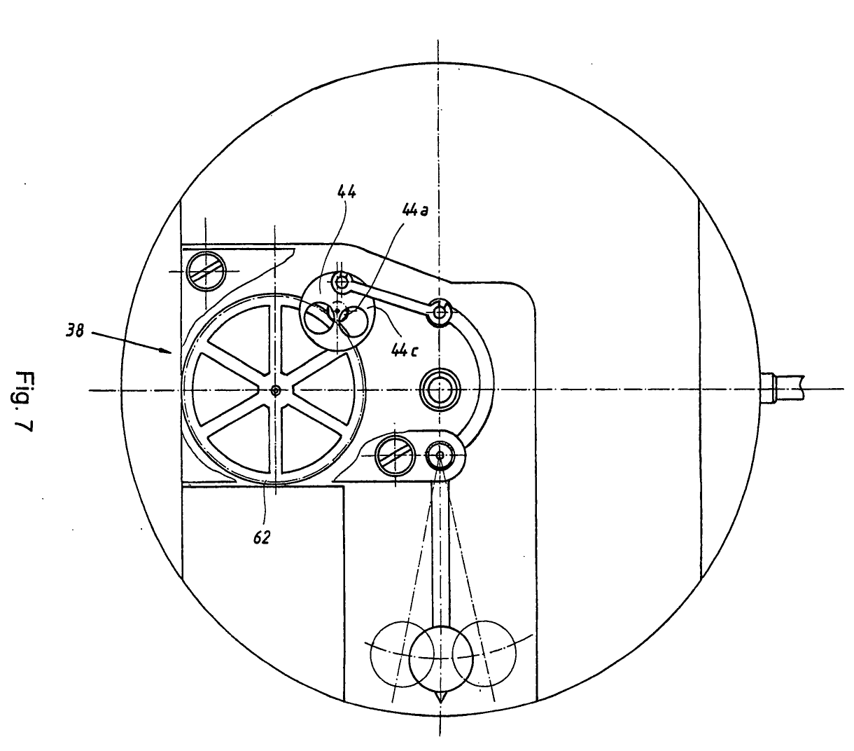

FIG. 6 is a sectional view of a second embodiment of a movement according to the invention, and

FIG. 7 represents a third embodiment of the invention.

The watch represented in FIG. 1 comprises a case 10 defining a receptacle in which there is disposed a watch movement which will be described with reference to FIGS. 2 to 5, which movement comprises a work train and a minute train bearing, respectively, second hands 12, minute hands 14 and hour hands 16. A dial 18 is interposed between the movement and the hands. It is pierced by a window 20, through which can be seen an animation part 22, arranged in such a way as to simulate the movement of a pendulum, as will be explained below.

FIG. 2 shows, in top view, a watch movement 24 according to the invention, such as that housed in the case 10. The dial has been removed. The hands 12, 14 and 16 are visible in transparency. The animation part 22 can likewise be seen. Its extreme positions are shown in dotted representation.

The movement 24 comprises a base caliber 26, represented schematically in side view in FIG. 3, ensuring the vital functions of a timepiece, i.e. the power supply, the generation of a base frequency, the mechanical division by means of trains, as well as the correction functions. Its time base can equally well be a quartz as a hairspring.

The caliber 26 is, in particular, equipped with a plate and with a bridge (neither of which is referenced) and with a work train comprising mobiles which are pivotably mounted between the plate and the bridge, only the end of the seconds mobile 30 being visible in FIG. 3. A minute train, which is also not represented, bears and carries out the driving of the minute hands 14 and hour hands 16.

The base caliber 26 bears a module 32 comprising a plate 34 and a bridge 36 which, together, serve as support for an animation train 38. The latter comprises three mobiles 40, 42 and 44, each formed by a pinion identified by the letter a, and by a wheel identified by the letter b, with the exception of the mobile 44, which comprises a pinion 44a and a board 44c, but no wheel.

The mobile 40 is coaxial to the seconds wheel 30. Its pinion 40a is equipped with a hole engaged in the end of the seconds mobile 30, the hole and the end being arranged in such a way that the mobiles 30 and 40 rotate as one, for example owing to an indenting arranged on the pinion 40a, the mobile 40 being in this case press-fitted on the end of the mobile 30.

The wheel 40b drives the pinion 42a and, with it, the wheel 42b, which meshes with the pinion 44a of the mobile 44.

The mobiles 40, 42 and 44 are numbered in such a way that the speed of rotation of the mobile 44 is of the order of 1 revolution per second, typically ranging between 0.2 and 2 revolutions per second.

The mobiles 40 and 42, as well as the pinion 44a, are disposed and pivot between the plate 34 and the bridge 36. As can be seen in FIG. 5, the pinion 44a is equipped with a pivot 44d projecting from the bridge 36 and on which the board 44c is press-fitted. The latter supports a rod 44e, the function of which will be specified further below.

The animation part 22 comprises a central portion 22a (FIG. 2) equipped with a hole in which a shaft 22b, pivotably mounted between the plate 34 and the bridge 36, proximate to the center of the movement, is press-fitted. Two arms 22c and 22d extend on either side of the central portion 22a. The free end of the arm 22c bears a bob 22d, which is apparent through the window 20 and simulates the bob of a pendulum. The end of the other arm 22d is equipped with a rod 22e, which can better be seen in FIG. 5 and is intended to secure a connection with the board 44c, via a lever 46 pivotably mounted on the rods 44e and 22e. Thus, the mobile 44 and the lever 46 together form a control element for the animation part 22.

The lever 46 bears two watchmaker's jewels 46a and 46b, press-fitted respectively at one and the other of its ends and cooperating one with the rod 22e, the other with the rod 44e. In its middle part 46c, it has a serpentine structure, which lends it greater elasticity than that of a straight bar.

The lever 46 is held on the rods 22e and 44e by sleeves 48 press-fitted on the rods 22e and 44e, leaving a sufficient space with the jewels 46a and 46b to ensure that these are not impeded in their movement.

The mobile 44 and the lever 46 thus together form a connecting rod system driving the animation part 22.

In the watch which has just been described, when it is of the hairspring type, the seconds wheel performs a slight jump each time that the escapement gives an impetus to the balance wheel. This occurs with each semioscillation, i.e. from 5 to 10 times per second. This frequency is too low to simulate a continuous movement. In practice, the duration of the impetus is of the order of 1% of the time of the half-period. For the pendulum to give the illusion of having a continuous and sinusoidal movement, it is necessary to introduce an element which dampens the movement. It is the function of the serpentine structure 46c, which lends a greater elasticity to the lever 46.

By way of a variant, the elastic structure 46c of the lever 46 could be replaced by mounting the wheel 42b in a freely rotatable manner on the pinion 42a and by connecting them by a flat spiral spring. This variant has not been represented in the drawing, for it is easily realizable by a person skilled in the art.

In order to obtain an optimal simulation, the period of the unit formed by the animation part 22 and the elastic element 46b ranges between that defined by the periodicity of the advancement of the work train and that of the oscillating movement of the animation part 22.

Advantageously, and in order that the oscillation movement of the animation part 22 suffers the least possible perturbations, the unit formed by the lever 46 and the animation part 22 is balanced, that is to say that its center of gravity is located substantially on the pivot axis of the part 22.

The way of ensuring the connection of the animation part 22 with the animation train 38 could be realized by other means than those represented and described. It is thus possible to realize an animation part whose arm 22d would be considerably shortened and would bear a pin. The lever 46 would be replaced by a fine spring, fixed on the pin of the lever 22d. The other end of the spring would be equipped with a protuberance in which a jewel similar to that bearing the reference 46b would be press-fitted. It would thereby be possible to have a more flexible elastic element.

Self-evidently, the animation part could equally have a form other than that of a pendulum, with its verge and its bob, without for all that departing from the scope of the invention. The animation part could thus have the form of a boat, the oscillating movement simulating the movement of the waves, or of any other object performing a slow pendular movement.

It is also possible, of course, to integrate the components ensuring the drive of the animation part directly onto the plate of the base caliber.

The embodiment represented in FIG. 6 allows the smoothness of the movement of the automaton to be further improved. In this figure, only the mobiles have been represented. They pivot, self-evidently, within the frame of the movement, generally between a bridge and the plate. In this embodiment, the driving element, which supplies the power to the work train, is formed by a barrel spring, housed in a barrel 50, constituting the first mobile of the work train, the latter driving an escapement and a hairspring, which together form a pulsed movement element. The animation train comprises five mobiles 52, 54, 56, 58 and 60.

The mobile 52 comprises a pinion 52a, in mesh with the toothing of the barrel 50, and a wheel 52b, which drives the mobile 54 via its pinion 54a. The latter is attached to a collet 54b, fixed by press-fitting and bearing a balance spring 54c. A wheel 54d is mounted loose on the pinion 54a, held axially in place by a ring 54e press-fitted on the shaft of the pinion 54a. It is equipped with a stud 54f fixed to the end of the balance spring 54c. The balance spring 54c is fixed on the collet 54b and on the stud 54f in traditional manner, for example by gluing or welding. The pinion 54a and the wheel 54d thereby rotate as one, but are elastically connected one to the other, dampening the jerks due to the jerky movements of the balance wheel. It is also possible to realize the balance spring 54c and its fixing means, i.e. the collet 54b and the stud 54f, in a single piece, press-fitted on the pinion 54a and on a stud contained on the wheel 54d.

The wheel 54d meshes with the mobile 56 and, more particularly, with its pinion 56a, whereas its wheel 56b drives the mobile 58 via its pinion 58a. The wheel 58b meshes with the pinion 60a of the mobile 60. The latter comprises a board 60b bearing a rod 60c, similar to the rod 44e, and on which pivots the lever 46.

The board 60b will be dimensioned such that it forms a sufficient mass of inertia to enable the balance spring 54c to remain slightly wound, such that the pendulum continues moving between two alternations of the balance wheel. The dimensioning of the balance spring and of the mass of inertia will be all the more delicate since the power will be tapped from a rapid mobile of the gear work train.

The tapping could equally be effected from the center wheel or from the third wheel. Nevertheless, by tapping the power at the level of the barrel, the number of mobiles contained between the element animated by a pulsed movement, i.e. the escapement, and the element simulating a sinusoidal movement, i.e. the pendulum, is such that their elasticity is sufficient to make the impetuses of the balance wheel invisible. It is not therefore essential to add a supplementary elastic element, even if the animation part oscillates at a relatively high frequency, for example 2 Hz.

FIG. 7 shows another embodiment of the invention, in which the animation train 38 is confined to a wheel 62 disposed on the shaft of the seconds wheel of the work train and the last mobile 44, whose pinion 44a meshes with the wheel 62. As explained above, the board 44c drives the animation part 22.

The gearing ratio between the wheel 62 and the pinion 44a is advantageously 1/12, such that the period of the animation part is 5 seconds. In this case, the pulsed movement of the work train is heavily reduced, on the one hand due to the high moment of inertia of the wheel 62, on the other hand due to the very small displacement of the animation part with each alternation of the balance wheel.

In order to prevent the gear shakes of the animation train from generating random movements of the animation part, it is possible to equip the latter with a brake working upon the end of a pivot of its shaft.

In the examples described above, the control element for the animation part is of the crank type. The same effect could be obtained by means of a cam and a lever resting against the cam.

Thus, by virtue of the particular characteristics exhibited by the movement according to the invention, it is possible to realize a watch equipped with a slow animation which tends to bring a touch of serenity and calm, contrasting with the normal conditions of everyday life, and thus offering a little bit of calm to the wearer, even when he reads the time. Moreover, the presence of a wheel train allows the pivot point of the animation part to be placed almost anywhere, and especially in the immediate vicinity of the center of the movement, which lends the watch an original esthetic appearance.

1. A mechanical-type watch movement, comprising a frame supporting:
a work train comprising a plurality of mobiles periodically driven in rotation by a driving element,
a mobile animated by a pulsed movement, and having a kinematic connection with the work train,
an animation part configured to be visible and arranged to be animated by a periodic movement,
a control element for the animation part, and
an animation train in mesh with a mobile of the work train, the animation train driving the control element,
wherein the control element and the animation part are arranged so that the periodic movement is of a sinusoidal oscillating type, and
wherein an elastic element interposed between the mobile of the work train and the animation part, the elastic element being configured to smooth out the movement of the animation part.

2. (canceled)

3. The movement of claim 1, wherein the mobile of the work train is a seconds mobile, and the animation train is arranged to accelerate the rotation speed of the seconds mobile toward a last mobile of the animation train cooperating with the animation part.

4. The movement of claim 3, wherein the animation part oscillates at a frequency ranging between 0.2 and 2 Hz.

5. The movement of claim 1, further comprising a lever having first and second ends, and a last mobile of the animation train comprising a board, wherein the animation part and the board are equipped with eccentrically disposed connecting members connected to one of the ends of the lever.

6. The movement of claim 5, wherein the lever has, over at least a part of its length, an elastically deformable structure, configured to form the elastic element.

7. The movement of claim 1, wherein the elastic element elastically connects two coaxially disposed mobiles of the animation train.

8. The movement of claim 7, wherein the elastic element forms, with the animation part and the mobiles of a train interposed between that which cooperates with the animation part and that which is connected to the elastic element, an oscillating system, having a period ranging between that of the mobiles of the work train and that of the periodic movement of the part.

9. The movement of claim 1, wherein the animation part is mounted pivotably on the frame by a pivot axis and has a center of gravity located substantially on the pivot axis.

10. The movement of claim 1, wherein the frame comprises:
a first plate and a first bridge, between which the mobiles of the work train pivot, and
a second plate on which the mobiles of the animation train and the animation part pivot,
the second plate, the animation train and the animation part forming an independent module configured to be fixed by the second plate onto the first plate.
